(19) United States
(12) Patent Application Publication
(10) Pub. No.: US 2004/0095204 A1
(43) Pub. Date: May 20, 2004

(54) Capacitive coupler for power line communications

(75) Inventor: Yehuda Cern, Brookline, MA (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: AMBIENT CORPORATION

(21) Appl. No.: 10/699,918

(22) Filed: Nov. 3, 2003

Related U.S. Application Data
(60) Provisional application No. 60/424,241, filed on Nov. 6, 2002.

(51) Int. Cl. H01P 5/12

(52) U.S. Cl. 333/100; 340/310.01

(57) ABSTRACT

There is provided a signal coupling apparatus. The signal coupling apparatus includes a circuit having (a) a capacitor for coupling a signal to a power line, and (b) a switch in series with said capacitor. The circuit is for connection between the power line and another circuit. There is also provided a method for using such a signal coupling apparatus.

### CROSS-REFERENCE TO RELATED APPLICATIONS

The present application is claiming priority of U.S. Provisional Patent Application Serial No. 60/424,241, filed on Nov. 6, 2002, the content of which is herein incorporated by reference.

### BACKGROUND OF THE INVENTION

1. Field of the Invention

The present invention relates to capacitive couplers for power line communications, and more particularly, to a capacitive coupler that is connectable to a live power line.

2. Description of the Related Art

One operational issue for a medium voltage capacitive power line coupler relates to an installation procedure for a live AC voltage line. Prior to installation, a capacitor in the coupler is discharged. Except for the unlikely case that the moment at which the coupler is attached to the AC line is precisely at a time that the AC voltage crosses zero, there will be a charging current that is limited only by the coupler's impedance.

A physical attachment process is not a clean, one-time contact, but rather, is subject to contact bounce, so that there may be a plurality of discrete contact times and a corresponding plurality of current pulses. If the capacitor is charged to line voltage of one polarity and then momentarily disconnected and thereafter reconnected at the opposite polarity, then an even stronger charging current will flow, perhaps accompanied by sparking.

One of the most likely times for a faulty capacitor to explode is at this time of physical attachment and maximum stress. A utility lineman nearby the capacitor is at a risk of injury.

### SUMMARY OF THE INVENTION

An embodiment of the present invention is a signal coupling apparatus. The signal coupling apparatus includes a circuit having (a) a capacitor for coupling a signal to a power line, and (b) a switch in series with the capacitor. The circuit is for connection between the power line and another circuit.

Another embodiment of the present invention is a method for attaching a coupling capacitor to an energized power line. The method includes providing a circuit having a switch in series with the coupling capacitor, connecting a terminal of the circuit to the energized power line, and closing the switch.

Yet another embodiment of a method in accordance with the present invention includes (a) connecting a capacitor to a power line, (b) connecting a resistor in series with the capacitor, and (c) connecting a switch in parallel with the resistor to effect a connection between the capacitor and a circuit.

### BRIEF DESCRIPTION OF THE DRAWINGS

FIG. 1 is a schematic diagram of a capacitive coupler with a remotely actuated connection switch.

FIG. 2 is a schematic diagram of a capacitive coupler that includes a charging resistor to limit current flow of a charging pulse during attachment of the capacitive coupler to a power line.

### DESCRIPTION OF THE INVENTION

A capacitive coupler is an apparatus for coupling a signal, e.g., a data signal, to a power line. The present invention limits a risk of injury to a lineman and limits other damage that may otherwise occur during attachment of a capacitive coupler to a live power line.

In one embodiment of the invention, a capacitive coupler includes a capacitor and a switch that places an open circuit in series with the capacitor. The switch may be actuated by a lineman at a safe distance from the capacitor using a lanyard so that no personnel will be nearby at the time of actuation. Alternatively, the switch may be automatically actuated by a time delay mechanism, giving the lineman time to distance himself from the capacitive coupler before actuation. This is particularly advantageous in a case where the capacitor explodes when the switch is actuated.

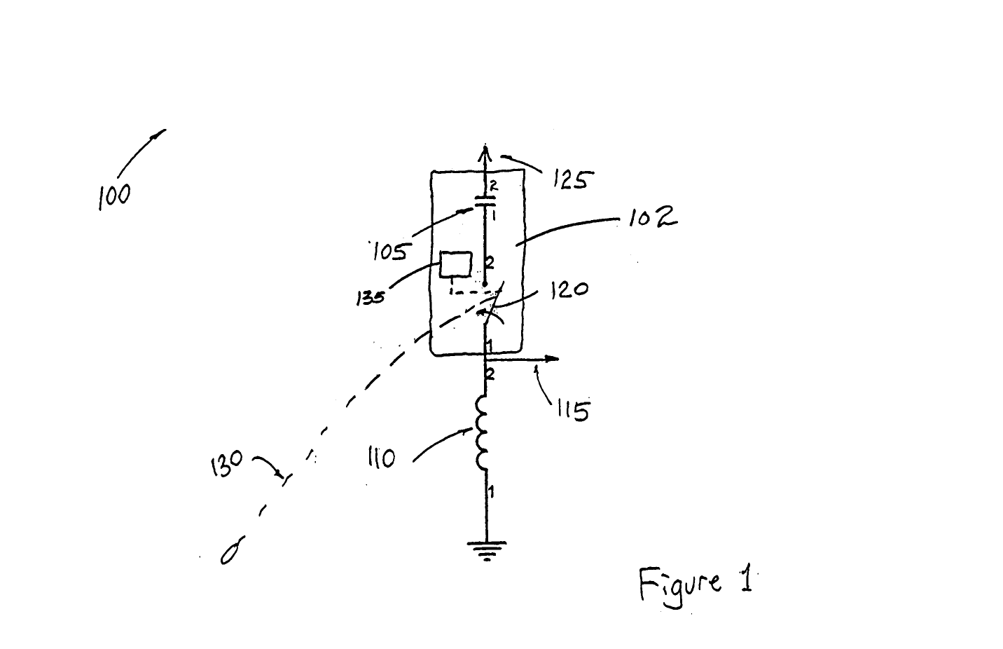

FIG. 1 is a schematic diagram of a capacitive coupler 102 configured in accordance with the present invention. Capacitive coupler 102 includes a capacitor 105 and a switch 120. Capacitive coupler 102 is connected between a power line 100 and a choke 110 that is part of a grounded circuit.

Each of capacitor 105, switch 120 and choke 110 has a first terminal and a second terminal. Capacitor 105, switch 120 and choke 110 are connected in series with one another. FIG. 1 shows an exemplary series arrangement where the first terminal of choke 110 is grounded, the second terminal of choke 110 is connected to the first terminal of switch 120, the second terminal of switch 120 is connected to the first terminal of capacitor 105, and the second terminal of capacitor 105 is connected to a clamp 125. Note however that the invention is not limited to the series arrangement of choke 110, switch 120 and capacitor 105 shown in FIG. 1. For example, a terminal of switch 120 could be connected to power line 100, and capacitor 105 could be connected between switch 120 and choke 110.

Initially, clamp 125 is not connected to anything, and consequently the second terminal of capacitor 105 is electrically open. But eventually, as explained below, clamp 125, and thus the second terminal of capacitor 105, will be connected to a power line 100.

Choke 110 is a signal frequency choke for signals communicated via a communications device (not shown). A connection 115, which coincides with the connection between the second terminal of choke 110 and the first terminal of switch 120, is provided to the communications device.

An insulating material, e.g., a lanyard 130, is used to actuate switch 120. Lanyard 130 is a cord that allows a lineman to close and open switch 120 at a safe distance from capacitive coupler 102. An appropriate safe distance depends on factors such as a voltage level on power line 100, but such distance is preferably at least 10 meters. The insulating material need not be a cord, but could be any suitable form, such as, for example, a pole. Switch 120 is initially set to its nonconducting, i.e., opened, position.

Alternatively, a time delay actuated switch may be used, providing the lineman sufficient time to move away a safe distance. For example, a time delay mechanism 135 may provide 10-30 seconds delay, or any desired delay. Time delay mechanism 135 is preferably operable before beginning installation of capacitive coupler 102, so as to confirm to the lineman that time delay mechanism 135 is working properly.

A method for attaching capacitor 105 begins by using clamp 125 to connect the upper, i.e., second, terminal of capacitor 105 to power line 100. After making the connection, a lineman positions himself at a safe distance from capacitive coupler 102, at the end of the lanyard 130, and pulls lanyard 130 to change the setting of switch 120 to its conducting, i.e., closed, position.

While the method is illustrated herein in the context capacitive coupler 102 being grounded, it is also applicable to a connection of capacitive coupler 102 between two power line phase wires. The method is also applicable to an attachment of a capacitor used as a signal frequency shunt, or an attachment of a capacitor for any other purpose.

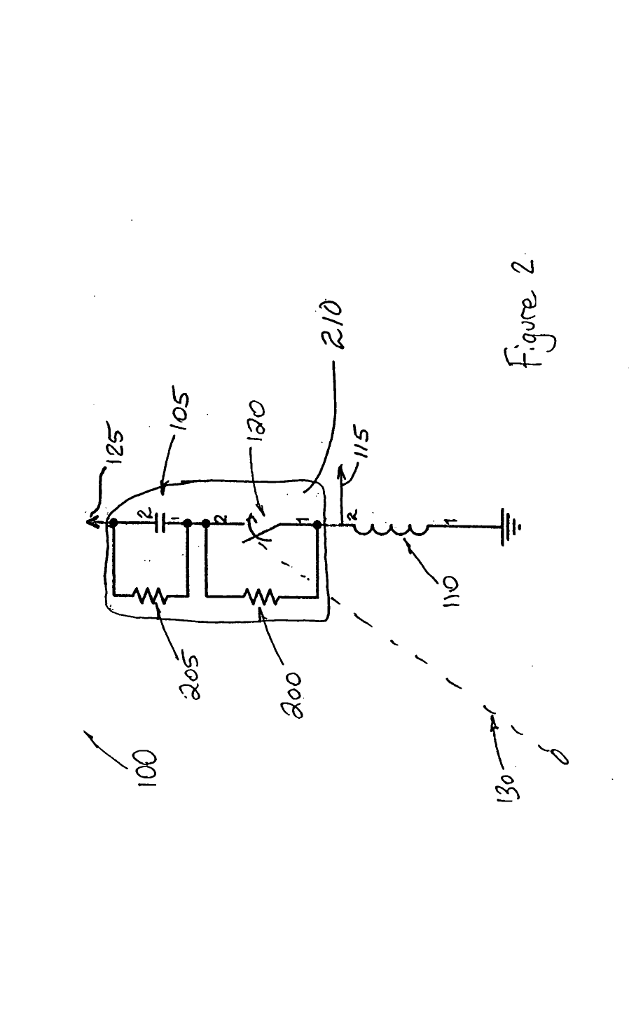

FIG. 2 is a schematic diagram of a capacitive coupler 210 that limits current flow of a charging pulse during attachment of capacitive coupler 210 to a power line. Capacitive coupler 210, similarly to capacitive coupler 102 includes capacitor 105 and switch 120, and it further includes a charging resistor 200. Optionally, capacitive coupler 210 may also include a bleeder resistor 205.

Charging resistor 200 is connected in parallel with switch 120, so as to allow capacitor 105 to charge in a period of time between an attachment of clamp 125 to power line 100 and actuation, i.e., closing, of switch 120. A product of charging resistor 200's resistance and capacitor 105's capacitance is an RC time constant that is preferably substantially less than a period of the power frequency, but large enough to limit the initial attachment current to a small value. The RC time constant is preferably less than 1/10 of the period of the power frequency. For example, assuming a 60 Hz power frequency and therefor a period of approximately 16.67 ms, RC should be about 1.7 ms. Thus, for a typical coupling capacitor of 3 nanofarads (nF), R would be 567 k ohms. For a phase voltage of 8 kV, the charging current would be limited to less than 20 milliamps (mA) peak.

With charging resistor 200 being included in capacitive coupler 210, within a small fraction of a second, about three time constants, or 5 ms for the example above, a voltage across capacitor 105 will closely follow a voltage on power line 100, and a voltage across switch 120 will fall to a small fraction thereof. As the voltage across capacitor 105 closely follows the line voltage, a magnitude of a charging current pulse is limited during actuation of switch 120. As the magnitude of the charging current pulse is reduced, stress on capacitor 105 and probability of a capacitor fault are also reduced.

Bleeder resistor 205 discharges capacitor 105 when capacitive coupler 210 is disconnected from power line 100. This prevents injury to a lineman that could otherwise be caused by a charge stored in capacitor 105. Bleeder resistor,205 should have a resistive value of at least 100 times greater than that of charging resistor 200.

It should be understood that various alternatives and modifications of the present invention could be devised by those skilled in the art. Nevertheless, the present invention is intended to embrace all such alternatives, modifications and variances that fall within the scope of the appended claims.

What is claimed is:

1. A signal coupling apparatus, comprising:
a circuit having
(a) a capacitor for coupling a signal to a power line; and
(b) a switch in series with said capacitor,
wherein said circuit is for connection between said power line and another circuit.

2. The signal coupling apparatus of claim 1, wherein said another circuit is a grounded circuit.

3. The signal coupling apparatus of claim 1, wherein said capacitor includes a terminal for connection to said power line.

4. The signal coupling apparatus of claim 1, further comprising a component for remotely actuating said switch.

5. The signal coupling apparatus of claim 1, further comprising an insulating cord for actuating said switch.

6. The signal coupling apparatus of claim 1, further comprising a time delay mechanism for actuating said switch.

7. The signal coupling apparatus of claim 1, further comprising a resistor in parallel with said switch, wherein said resistor and said capacitor form an RC time constant that is substantially less a period of a power frequency on said power line.

8. The signal coupling apparatus of claim 7,
wherein said resistor is a first resistor having a first resistance,
wherein said signal coupling apparatus further comprises a second resistor connected in parallel with said capacitor and having a second resistance, and
wherein said second resistance is at least one hundred times greater than said first resistance.

9. A method for attaching a coupling capacitor to an energized power line, comprising:
providing a circuit having a switch in series with said coupling capacitor;
connecting a terminal of said circuit to said energized power line; and
closing said switch.

10. The method of claim 9, where said connecting comprises connecting a terminal of said capacitor to said power line.

11. The method of claim 9, wherein said closing comprises actuating said switch from a location remote from said switch.

12. The method of claim 9, wherein said closing comprises using an insulating cord to actuate said switch.

13. The method of claim 9, wherein said closing comprises using a time delay mechanism for actuating said switch.

14. A method comprising:
connecting a capacitor to a power line;
connecting a resistor in series with said capacitor; and
connecting a switch in parallel with said resistor to effect a connection between said capacitor and a circuit.
